(19) United States
(12) Patent Application Publication
(10) Pub. No.: US 2004/0201474 A1
(43) Pub. Date: Oct. 14, 2004

(54) Panic alert system

(76) Inventor: Eros P. Vladovich, Naperville, IL (US)

Correspondence Address: Raymond Y. Chan, Suite 128, 108 N. Ynez Ave., Monterey Park, CA, 91754, US

(21) Appl. No.: 10/411,851

(22) Filed: Apr. 14, 2003

(51) Int. Cl. G08B 1/08

(52) U.S. Cl. 340/539.11; 340/573.1; 340/574

(57) ABSTRACT

A panic alert system includes an alert device adapted for placing at a desired location, a mounting device for detachably mounting the alert device on the desired location in position, and a remote activator communicating with the alert device to remotely control the alert device to be activated, wherein the alert device includes a portable case and a panic signal generator received therein in such a manner that when the alert device is activated, the panic signal generator is arranged to generate panic signals for drawing attention to the desired location.

### BACKGROUND OF THE PRESENT INVENTION

1. Field of Invention

The present invention relates to an alert system, and more particularly to a panic alert system which comprises a portable alert device and a remote activator to wirelessly activate the alert device for providing a panic signal. In addition, the panic alert system is easy to operate and does not require special installation for all kinds of condition such as outdoors or indoors.

2. Description of Related Arts

Most residences, facilities, and vehicles have installed security alarm systems to monitor the properties from burglars and accidents. A conventional security alarm system, such as burglary alarm system, generally comprises a control system to control a plurality of security devices, such as motion detectors for detecting human action within the protection areas, window sensors for detecting any damage thereof, opening contacts such as door/window switches for detecting in and out of people, and alert devices including communication devices such as voice dialer and/or digital dialer and audible and visual alarm devices for providing local alarm when burglar breaks in the protection area. Due to the security purpose, most people would like to install such security alarm system in their houses and/or the vehicle to protect their properties. These alarms and/or security systems are focused on intrusion detection.

However, such alarm system has several drawbacks. All the security devices must be properly installed. For example, the motion detectors and the window sensors must be electrically wired to each single room of a house/facility from the control system for house installation. Since the installation of the conventional security alarm is complicated and costly, a qualified technician is required to install the conventional security alarm. An improper installation of such security alarm may cause a false alarm or even damage the electrical wiring system of the house, facility, or vehicle.

In addition, the user must install different security alarm systems for his of her properties. For example, the house of the user must employ one kind of security alarm system and the vehicle of the user must employ another kind of security alarm system. Therefore, the user will pay an extremely high cost for those security alarm systems.

Furthermore, the security alarm system must be manually activated in order to set the security alarm system in an armed condition. In other words, once the security alarm system is in a disarmed condition, the security alarm system will lose the security feature. It is known that there are many ways to deactivate the security alarm system so that even though the security alarm system is installed into the house, the security alarm system can easily be disabled.

Also, false alarms are the unsolved troubles to both the alarm companies and the police resources. Most alarm owners have the unpleasant experience of being awaken in mid-night by the alarm company due to false alarms. Moreover, unaccountable waste of time and police force have been suffered by most of the policemen.

Therefore, a kind of portable panic alert system is highly desired in market so that the user may move the alarm system from place to place, such as from one room to another room, from one vehicle to another vehicle or from home to a vehicle, independently for security purposes. In other words, the conventional security alarm system cannot be used under certain circumstances. For example, the security alarm system cannot be temporarily installed into a rental car and cannot be carried while outdoor activities, such as camping.

The difference between the security alarm system and the panic alert system is that the panic alert system provides the ability to activate an alert device in order to draw attention to the surrounding area. Unlike the security alarm system, the panic alert system does not require an activation of the control panel to set the alert device in an armed condition. However, the panic alert system provides a similar alarm effect generated by the alarm system while the user directly activates the panic alert system to draw significant attention to the surrounding area.

### SUMMARY OF THE PRESENT INVENTION

A main object of the present invention is to provide a panic alert system, which comprises a portable alert device and a remote activator to wirelessly activate the alert device for providing a panic signal.

Another object of the present invention is to provide a panic alert system, which. is a self-contained alert system to provide a panic signal in order to draw attention to the surrounding area.

Another object of the present invention is to provide a panic alert system, wherein the alert device is placed in desired location to communicate with the remote activator in a wireless manner that once the remote activator is triggered, an activating signal is sent to the alert device for activating the alert device to provide panic signals, such as siren and high intensity flashing light, for a predetermined period of time. Therefore, the thief or burglar has no way to determine where is the alert device and to disarm or destroy it simultaneously.

Another object of the present invention is to provide a panic alert system, wherein no installation is required for the alert device such that the user is able to carry the alert device places to places where the properties are needed to be protected.

Another object of the present invention is to provide a panic alert system, which can form a powerful security community to substantially enlarge the protection area by selectively placing the portable alert device at a desired location, such as the neighbor, such that once the alert device is activated by the remote activator, the panic signal will draw the neighbor's attention.

Another object of the present invention is to provide a panic alert system, wherein the alert device is relatively economic in cost so that it is affordable to everybody. Moreover the alert device is so handy that it is adapted to be employed with any real estate properties, such as house or facility, or moving properties, such as air aircraft or vehicle.

Accordingly, in order to accomplish the above objects, the present invention provides a panic alert system, comprising:

an alert device, which is adapted for placing at a desired location, comprising a portable case and a panic signal generator received therein wherein when the alert device is activated, the panic signal generator is arranged to generate panic signals for drawing attention to the desired location and simultaneously generate an audio and visual emergency signal;

means for detachably mounting the alert device on the desired location in position; and

a remote activator communicating with the alert device to remotely control the alert device to be activated.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a panic alert system according to a preferred embodiment of the present invention.

FIG. 2 is a block diagram of the panic alert system according to the above preferred embodiment of the present invention.

### DETAILED DESCRIPTION OF THE PREFERRED EMBODIMENT

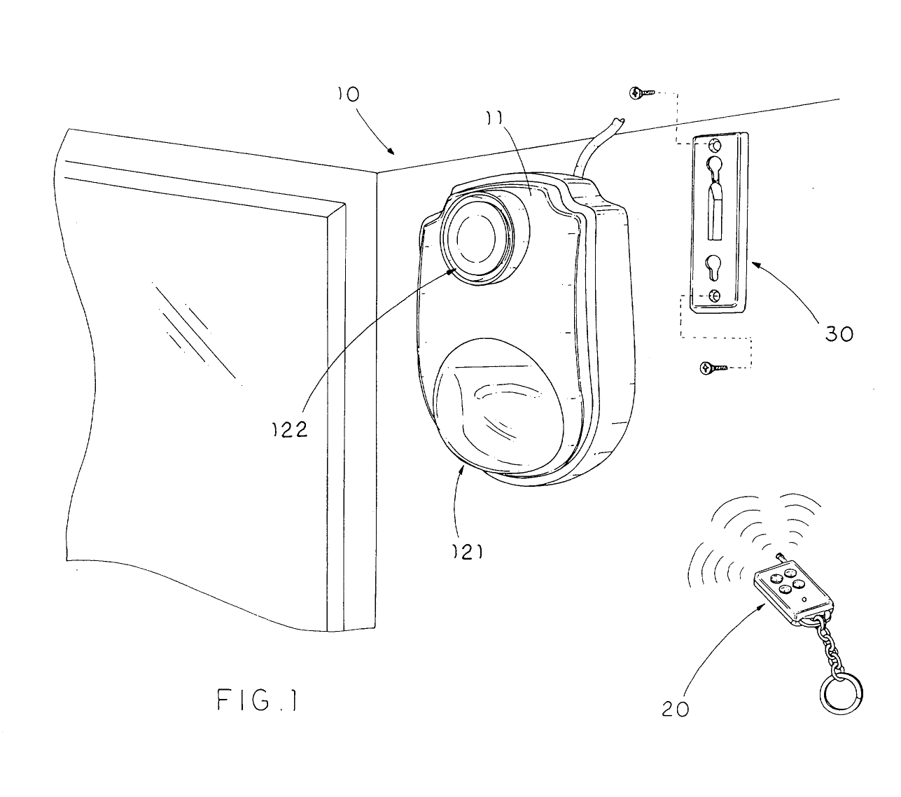

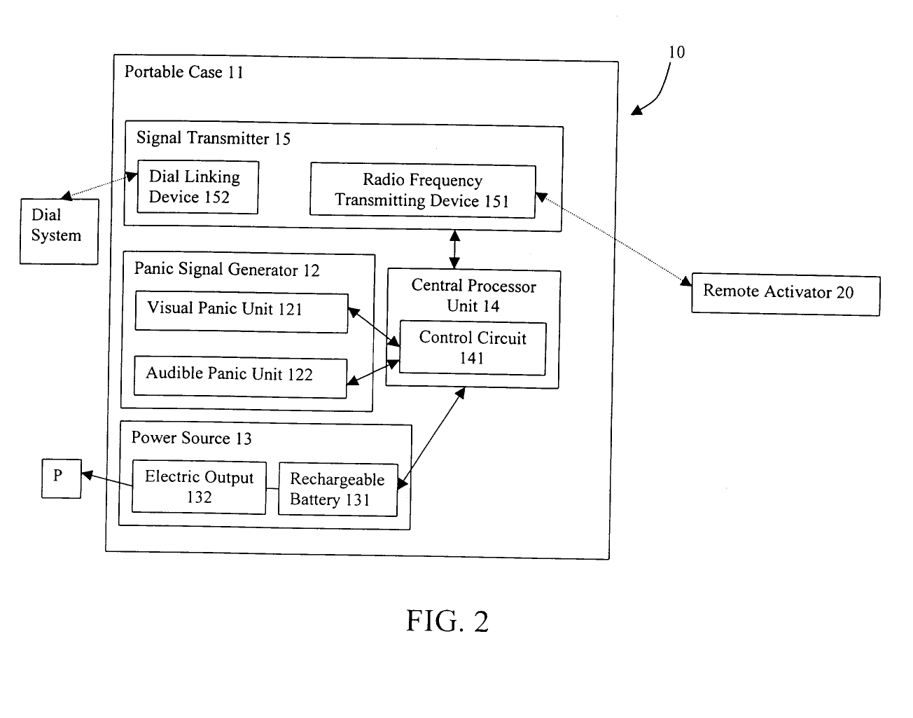

Referring to FIGS. 1 and 2, a panic alert system according to a preferred embodiment of the present invention is illustrated, wherein the panic alert system comprises an alert device 10 adapted for placing at a desired location, means 30 for detachably mounting the alert device 10 at the desired location in position, and a remote activator 20 communicating with the alert device 10 to remotely control the alert device 10 to be activated.

The alert device 10 comprises a portable case 11 and a panic signal generator 12 received therein wherein when the alert device 10 is activated, the panic signal generator 12 is arranged to generate panic signals for drawing attention to the desired location.

The panic signal generator 12 comprises a visual panic unit 121 and an audible panic unit 122 for producing visual and audible panic signals when the alert device 10 is activated. The panic signals generated by the panic signal generator 12 are intended to draw attention to the desired location in order to discourage the unauthorized activity of a thief, vandal, or intruder.

The alert device 10 further comprises a power source 13 received in the potable case 11, a control processor unit 14 electrically connected with the power source 13, and a signal transmitter 15 electrically connected to the control processor unit 14 for transmitting an activation signal between the alert device 10 and the remote activator 20.

As shown in FIG. 1, the portable case 11 is shaped and sized to have a compact body for the user to carry anywhere. Due to the portability of the panic alert system, no installation is required, wherein the portable case 11 of the alert device 10 is adapted for hanging or mounting on a wall structure or even placing on a floor in an installation-free manner through the mounting means 30.

The mounting means 30 is a conventional mounting device to detachably mount the portable case 11 at the desired location in position. As shown in FIG. 1, the mounting means 30 is constructed as a wall mount provided on the portable case 11 to hang or mount on the wall structure by using screws or anchors. The mounting means 30 can be a supporting stand to support the portable case 11 on the floor or in the vehicle in position. In other words, the user is able to set up the panic alert system of the present invention everywhere without using any tool.

The power source 13 of the alert device 10 comprises a rechargeable battery 131 disposed in the portable case 11 wherein the rechargeable battery 131 of the power source 13 is electrically connected to the control processor unit 14 to supply electricity. The power source 13 further comprises an electric output 132 is adapted for electrically connecting to an external power supply P so as to not only recharge the rechargeable battery 131 but also electrically connect the control processor unit 13 with the external power supply for electricity. The external power supply P can be the AC current power or a DC current power such that when the alert device 10 can be used indoors by hooking to the AC current power outlet or outdoors by hooking to the DC current power outlet which is extended from a battery of transportation such as aircraft, boat, or car.

The control processor unit 14 comprises a control circuit 141 electrically connected with the signal transmitter 15 wherein the control circuit 131 is arranged to control the panic signal generator 12 in such a manner that when the activation signal is sent from the remote activator 20 to the signal transmitter 15, the control processor unit 14 activates the panic signal generator 12 to generate the panic signals for a predetermined period of time. It is worth to mention that the panic signals generated by the panic signal generator 12 of the alert device 10 can be set as different kinds of signal through the control processor unit 14. For example, the alert device 10 can be selectively set to generate a siren signal as the panic signal or a flashing light as the panic signal.

In addition, the control processor unit 14 is arranged to control the configuration of the panic signal generator 12 such as the time period of the panic signals and the types of the panic signal. Thus, a default configuration is preset in the control circuit 141 of the control processor unit 14 such that the alert device 10 is capable of resetting to its original configuration through the control processor unit 14.

The signal transmitter 15 of the alert device 10 comprises a radio frequency transmitting device 151 adapted to send and receive a radio frequency as the activation signal, wherein the signal transmitter 15 functions as a wireless communication link between the control processor unit 14 and the remote activator 20. The signal transmitter 15 further comprises a dial linking device 152 adapted for wirelessly linking to a dial system such that when the alert device 10 is activated to produce the panic signals, the dial linking device 152 is automatically activated to transmit signals to the dial system so as to dial a preset phone number, such as a police station.

In other words, the signal transmitter 15 is tuned to communicate with the same radio frequency to the dial system such that the alert device 10 is capable of linking or connecting to a designated location such as the police station by sending the radio frequency signal from the signal transmitter 15 to the dial system. It is worth mentioning that since the panic alert system is incorporated with the radio frequency, no phone line is needed to link the alert device 10 to the dial system.

Accordingly, the remote activator 20 is communicating with the control processor unit 13 through wireless communication means such as radio frequency signal to remotely control the activation of the alert device 10. Basically, the remote activator 20 is used for activating and deactivating the alert device 10 through radio frequency. Therefore, no code is required for the user to input in order to activate and deactivate the alert device 10. Accordingly, the remote activator 20 is shaped and sized to have a compact unit that the user is able to put the remote activator 20 as a remote control in his or her pocket.

It is apparent that although the alert device 10 is convenient for carrying and using from place to place, the panic alert system according to the present invention is not limited to use the alert device 10 as the panic device. By incorporating the wireless communicating component, such as the signal transmitter 15 and the panic signal generator 12, in any existing alarm systems installed in vehicles, homes, building structures, the modified alarm systems can hook up with the panic alert system 10 any where any time.

Since no installation of the panic alert system of the present invention is required, the alert device 10 can be used as a portable alert system to enhance the security protection by selectively placing the alert device 10 at the desired location.

According to the preferred embodiment, the panic alert system is capable of functioning as a neighbor alert system wherein the alert device 10 is placed to the user's neighbor while the remote activator 20 is held by the user. Therefore, in case of emergency, the user is able to activate the alert device 10 via the remote activator 20 so that the panic signal generator 12 produces the panic signals to draw the neighbor's attention for help. In other words, the user's neighbor will call the police station instead of the user himself/herself call the police station because the user is unable to make the call under the panic situation.

Since the intruders can't determine which neighbors around the target building structure are placed with its alert device 10. It is impossible for the intruders to check every neighbor around the user. In the matter of fact, once the alert device 10 is activated to produce the panic signals, the intruder is unable to deactivates, destroy or disconnect the power of the alert device 10 since the alert device 10 is located far away from the remote activator 20.

It is worth to mention that the remote activator 20 can be constructed as a sensor switch to remotely activate the alert device 10. The remote activator 20 can be a motion sensor located at a predetermined detecting area or an entrance sensor located at the door or the window such that when the remote activator 20 detects a motion signal within the detecting area by the motion sensor or an unauthorized intrusion by the entrance sensor, the alert device 10 is automatically activated to produce the panic signals. Therefore, even though the user leaves his or her house, such as traveling, his or her house is still protected under the panic alert system of the present invention through the user's neighbor.

In addition, the panic alert system can be employed in a senior citizens house such that the elderly or the disabled person is able to notify the neighbor via the panic alert system of the present invention when he or she needs help.

The panic alert system of the present invention can be used as a personal alert system according to the portability of the alert device 10. Accordingly, the alert device 10 is excellent to be used in all kinds of vehicle, such as private boats that have to be parked at the harbors, container trucks and bus that have to be parked at the outdoor parking areas, and rental cars that have no stationary alarm system installed, by locating the alert device 10 in the enclosure thereof.

It can certainly be used in transportation cars, vans, sport utility vans, and etc. that although each of them may have a stationary alarm system installed, it can still provide additional and extended networked protection by placing the alert device 10 in the passenger chamber of the vehicle. It is dangerous to stop the intruder to invade into a vehicle. However, it is powerful that the user activates the alert device 10 via the remote activator 20 to produce the panic signals simultaneously so as to draw attention to the general area of the vehicle, which may minimize the lose of the user in the safest way.

Another example illustrates the panic alert system of the present invention as the personal alert system, wherein the alert device 10 is capable of locating at a carrying container for security purpose. When the user waits for the check in at the airport, he or she will usually put the carrying container aside until the departure time comes, so that the carrying container will be stolen easily. However, when the alert device 10 is incorporated with the conventional carrying container, the user is able to locate the carrying container so as to prevent the carrying container from being unintentionally stolen.

In addition, all the conventional carrying containers are looked similar and the user may merely pick up a wrong carrying container that is not belonging to him or her. It is known that there are thousands of carrying containers lost at the airport everyday while the carrying containers are either taken by fault or stolen. Therefore, the panic alert system of the present invention can effectively locate the carrying container through the panic signals. In this case, the flashing lights should be generated as the panic signals without interrupting with other people.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure form such principles. Therefore, this invention includes all modifications encompassed within the spirit and scope of the following claims.

What is claimed is:

1. A panic alert system, comprising:
an alert device, which is adapted for placing at a desired location, comprising a portable case and a panic signal generator received therein wherein when said alert device is activated, said panic signal generator is arranged to generate panic signals for drawing attention to said desired location;
means for detachably mounting said alert device at said desired location in position; and
a remote activator communicating with said alert device to remotely control said alert device to be activated.

2. A panic alert system, as recited in claim 1, wherein said panic signal generator is preset to generate said panic signals for a predetermined period of time.

3. A panic alert system, as recited in claim 2, wherein said panic signal generator comprises an audible panic unit to generate audio signals as said panic signals, selectively including tone siren for panic and tone siren for medical.

4. A panic alert system, as recited in claim 2, wherein said panic signal generator comprises a visual panic unit to generate visual signals as said panic signals.

5. A panic alert system, as recited in claim 2, wherein said panic signal generator comprises an audible panic unit and a visual panic unit to respectively generate audio signals and visual signals as said panic signals simultaneously.

6. A panic alert system, as recited in claim 1, wherein said alert device further comprises a power source received in said portable case, a control processor unit electrically connected with said power source, and a signal transmitter electrically connected to said control processor unit for transmitting an activation signal between said alert device and said remote activator.

7. A panic alert system, as recited in claim 2, wherein said alert device further comprises a power source received in said portable case, a control processor unit electrically connected with said power source, and a signal transmitter electrically connected to said control processor unit for transmitting an activation signal between said alert device and said remote activator.

8. A panic alert system, as recited in claim 6, wherein said signal transmitter of said alert device comprise a radio frequency transmitting device adapted to send and receive a radio frequency as said activation signal, wherein said signal transmitter functions as a wireless communication link between said control processor unit and said remote activator.

9. A panic alert system, as recited in claim 7, wherein said signal transmitter of said alert device comprises a radio frequency transmitting device adapted to send and receive a radio frequency as said activation signal, wherein said signal transmitter functions as a wireless communication link between said control processor unit and said remote activator.

10. A panic alert system, as recited in claim 8, wherein said signal transmitter further comprises a dial linking device adapted for wirelessly linking to a dial system, wherein said dial linking device is tuned to a predetermined radio frequency with respect to said dial system for communicating said alert device with said dial system.

11. A panic alert system, as recited in claim 9, wherein said signal transmitter further comprises a dial linking device adapted for wirelessly linking to a dial system, wherein said dial linking device is tuned to a predetermined radio frequency with respect to said dial system for communicating said alert device with said dial system.

12. A panic alert system, as recited in claim 6, wherein said control processor unit comprises a control circuit electrically connected with said signal transmitter wherein said control circuit is arranged to control said panic signal generator in such a manner that when said activation signal is sent from said remote activator to said signal transmitter, said control processor unit activates said panic signal generator to selectively generate audio signals and visual signals as said panic signals.

13. A panic alert system, as recited in claim 8, wherein said control processor unit comprises a control circuit electrically connected with said signal transmitter wherein said control circuit is arranged to control said panic signal generator in such a manner that when said activation signal is sent from said remote activator to said signal transmitter, said control processor unit activates said panic signal generator to selectively generate audio signals and visual signals as said panic signals.

14. A panic alert system, as recited in claim 9, wherein said control processor unit comprises a control circuit electrically connected with said signal transmitter wherein said control circuit is arranged to control said panic signal generator in such a manner that when said activation signal is sent from said remote activator to said signal transmitter, said control processor unit activates said panic signal generator to selectively generate audio signals and visual signals as said panic signals.

15. A panic alert system, as recited in claim 7, wherein said power source of said alert device comprises a rechargeable battery disposed in said portable case, wherein said rechargeable battery of said power source is electrically connected to said control processor unit to supply electricity.

16. A panic alert system, as recited in claim 11, wherein said power source of said alert device comprises a rechargeable battery disposed in said portable case, wherein said rechargeable battery of said power source is electrically connected to said control processor unit to supply electricity.

17. A panic alert system, as recited in claim 14, wherein said power source of said alert device comprises a rechargeable battery disposed in said portable case, wherein said rechargeable battery of said power source is electrically connected to said control processor unit to supply electricity.

18. A panic alert system, as recited in claim 15, wherein said power source of said portable wireless alarm device further comprises an electric output for electrically connecting to an external power supply so as to not only recharge said rechargeable battery but also electrically connect said control processor unit with said external power supply for electricity.

19. A panic alert system, as recited in claim 16, wherein said power source of said portable wireless alarm device further comprises an electric output for electrically connecting to an external power supply so as to not only recharge said rechargeable battery but also electrically connect said control processor unit with said external power supply for electricity.

20. A panic alert system, as recited in claim 17, wherein said power source of said portable wireless alarm device further comprises an electric output for electrically connecting to an external power supply so as to not only recharge said rechargeable battery but also electrically connect said control processor unit with said external power supply for electricity.
